(19) United States
(12) Patent Application Publication
(10) Pub. No.: US 2016/0161384 A1
(43) Pub. Date: Jun. 9, 2016

(54) DEVICE AND METHOD FOR STORING SAMPLE BODIES

(71) Applicant: UL LLC, Northbrook, IL (US)

(72) Inventors: Bahman SARABI, Krefeld (DE); Martin MEYER, Solingen (DE)

(21) Appl. No.: 14/780,829

(22) PCT Filed: Dec. 13, 2013
(86) PCT No.: PCT/EP2013/076502

§ 371 Date: Jan. 19, 2016

(30) Foreign Application Priority Data
Mar. 27, 2013 (EP) 13161231.9

(51) Int. Cl. G01N 3/60

(52) U.S. Cl. CPC G01N 3/60

(57) ABSTRACT

A storage device (100) for storing a sample body (200) is described, wherein the storage device (100) has an opening, wherein the opening comprises an upper region (101) and a lower region (103), wherein the opening is designed to ac-commodate the sample body (200), wherein the sample body (200) to be accom-modated has an upper part (201) and, along the axis of symmetry (202) thereof, a central part (203) adjoining the upper part (201), wherein the walls of the opening are designed such that, when the sample body (200) is accommodated, the central part (203) of the sample body (200) to be accommodated is located at a distance from the walls of the opening, perpendicularly to the axis of symmetry (202), wherein the walls of the upper region (101) form a lateral guide (105) for the upper part (20 I) of the sample body (200) in order to enable the upper part (20 I) of the sample body (200) to move along the axis of symmetry (202) of the sample body (200), wherein the lateral guide (105) is given by the walls of the upper region (101) bearing against the upper part (201) of the sample body (200) to be accommodated.

The invention relates to a storage device for storing a sample body, and to a temperature-control device.

Thermal ageing or degradation is the continuous and irreversible changing of the behavior of various materials when acted upon by relatively high temperature. If various materials are exposed to a relatively high temperature, these materials can develop several types of physical and/or chemical changes. For example, in the case of various materials, exposure to relatively high temperatures for relatively long time periods can induce progressive changes in the physical properties.

In order to investigate the behavior (or to perform quality control) of various materials after temperature-controlled storage of the materials to be tested (of plastic in particular), the materials must first be stored for a long time period while ensuring that the axis of symmetry does not change. The axis of symmetry and the axis of force introduction must not deviate from one another after storage, since this would falsify the results of the test due to impermissible transverse forces.

Document DE 37 41 429 A1, for example, describes a device for material testing, in particular for measuring changes in length and/or width of material samples clamped on a clamping or holding device. To this end, the samples are provided with markings that are used to determine length and/or width and that can be scanned using optical measuring sensors. The clamping or holding device is disposed in a heatable and/or coolable climate chamber with a measuring sensor equipped with an optically transparent window, which may be heated as necessary when the climate chamber is cooled. To this end, the device is equipped with two grip heads, which can be connected—in a non-illustrated manner—to cross arms, which are guided on guide columns and can be adjusted by means of drive spindles.

Document DE 36 05 154 A1 describes a material testing device comprising a sample holder, which can be moved relative to a frame and in which the sample can be heated and cooled, wherein it is ensured that operation of the heating device and the moving device is automatically halted at the normal or premature end of the test, and that the heating expansion and the cooling contraction of the entire test stand is automatically compensated for within the oven. The device contains a sample in the sample holder, which is connected to a piston, and contains a cylinder, which accommodates the piston and has a movement damping device for the piston. The device furthermore contains a part that is fixedly connected to the sample and the sample holder and is contact with the expansion measuring sensor.

Document DE 40 21 837 A1 describes a device for feeding samples into a measuring device, in particular samples for conducting material tests via loading with tension and/or pressure and/or bending, such as tearing-resistance measurements and the like in material testing devices equipped with clamping elements for the sample. The measuring device is therefore designed for conducting tearing-resistance measurements and is also suitable for use in climate chambers in particular. The samples are stored in sample holders, which are designed such that the samples are accommodated in a form-fit manner therein, in the central region thereof. The sample holders are therefore provided in particular for sensitive, e.g. elastomeric, materials, in order to ensure that these materials are not deformed before the actual measurement. The samples are clamped at the lower end of the sample holder by means of a pair of clamping springs.

The problem addressed by the invention is that of creating an improved storage device for storing a sample body, and a temperature-control device for accommodating the storage device.

The problems addressed by the invention are solved by the features of the independent claims. Preferred exemplary embodiments of the invention are set forth in the dependent claims.

According to embodiments of the invention, a storage device for storing a sample body is created, wherein the storage device comprises an opening, wherein the opening has an upper region and a lower region, wherein the opening is shaped to accommodate the sample body, wherein the sample body to be accommodated has an upper part, i.e. an upper shoulder, and, along the axis of symmetry thereof, has a central part adjoining the upper part, wherein the walls of the opening are formed such that, when the sample body is accommodated, the central part of the sample body to be accommodated is located at a distance from the walls of the opening, perpendicular to the axis of extension, wherein the walls of the upper region form a lateral guide for the upper part of the sample body in order to permit the upper part of the sample body to move along the axis of symmetry of the sample body, wherein the lateral guide is given by the walls of the upper region bearing against the upper part of the sample body to be accommodated.

Embodiments of the invention could have the advantage that the sample body is held in the storage device such that the axis of symmetry does not change even after storage at a relatively high temperature. Therefore, deviation does not occur, for example, between the axis of symmetry and the axis of force introduction acting on the sample body in a subsequent tensile experiment. Nevertheless, the storage device enables the upper shoulder of the sample body to move along the axis of symmetry of the sample body.

The present invention could therefore have the advantage that, as viewed along the axis of symmetry of the sample body, the storage device permits thermal expansion of the upper part of the sample body along the axis of symmetry. This is possible while ensuring that the central part of the sample body—which is particularly relevant to a load measurement—cannot stick or adhere to the wall of the storage device. Nevertheless, the storage device is designed such that the upper part of the sample body is laterally protected by means of the lateral guide—against warping of the sample body; therefore, the sample body retains the shape thereof and cannot undergo unwanted warping upon thermal expansion. A lateral deformation of the sample body would have a disadvantageous effect on the test results, since all the forces would no longer act parallel to the sample body, e.g. in the case of a tensile test performed on the sample body. This would result in lateral forces, which would incorrectly represent the mechanical properties of the sample body.

According to an embodiment of the invention, the walls of the opening are formed such that, within the plane of extension and perpendicularly to the axis of symmetry of the sample body to be accommodated, the width of the opening is at least 1.5 times as wide as the central part of the sample body to be accommodated.

This could have the advantage that the central part of the sample body to be accommodated is free from material of the storage device perpendicularly to the plane of extension of the sample body to be accommodated. This means that the storage device does not have thermal contact with the sample body in this region and that gasses used to heat the sample body during the temperature-controlled storage of the sample body can flow uniformly around the central part of the sample body to be accommodated.

According to an embodiment of the invention, the size of the upper region—as viewed along the axis of symmetry of the sample body—is selected such that thermal expansion of the upper part of the sample along the axis of symmetry is made possible.

According to an embodiment of the invention, the sample body comprises—along the axis of symmetry—a lower shoulder (lower part) adjoining the central, parallel part, wherein the walls of the lower region limit a lateral movement of the lower part of the sample body, in which case the lower part of the sample body touches the lower region.

This could have the advantage that deformation of the lower part of the sample body is also prevented.

According to an embodiment of the invention, the storage device furthermore comprises a groove, wherein the groove has an upper wall, a lower wall, and the wall of the upper region of the opening, wherein the upper and the lower walls of the groove limit the movement of the upper part of the sample body to be accommodated —as viewed perpendicularly to the plane of extension of the sample body to be accommodated—in which case the upper part of the sample body to be accommodated touches the upper wall or the lower wall of the groove, wherein the groove is designed to permit the upper part of the sample body to be accommodated to move along the axis of symmetry.

The result thereof could be a guide for the upper part of the sample body that permits the thermal expansion of the sample body along an axis of symmetry and prevents the sample body from “falling out” of the storage device. The sample body is limited, by means of this guide, to deforming in a targeted manner along the axis of symmetry thereof, and “bending” in any other direction is ruled out.

According to an embodiment of the invention, the storage device furthermore comprises a clamp, wherein the clamp is designed to non-positively accommodate the upper part of the sample body, wherein the clamp has a first width within the plane of extension and perpendicularly to the axis of symmetry of the sample body to be accommodated, wherein the upper part of the sample body has a second width within the plane of extension and perpendicularly to the axis of symmetry of the sample body to be accommodated, wherein the aformentioned first width is greater than the aforementioned second width, wherein the walls of the upper region form the lateral guide, above the clamp, for the upper part of the sample body to be accommodated.

This could have the advantage that, due to the non-positive accommodation of the sample body, the upper part of the sample body cannot warp during temperature-controlled storage. For example, the upper shoulder of the sample body is enclosed by a pulling device when tensile tests are carried out. If the pulling device is unable to cleanly grip the upper part due to bending perpendicular to the plane of extension of the sample body, the upper part of the sample body could therefore break in this region. However, the non-positive accommodation of the sample body by the clamps counteracts any deformation of the upper part of the sample body during storage.

According to an embodiment of the invention, the groove forms the lateral guide, above the clamp, for the upper part of the sample body to be accommodated.

This could have the advantage that the upper part of the sample body does not have direct contact with the material of the storage device and the upper part of the sample body cannot melt during temperature-controlled storage and thereby become irreversibly connected to the storage device. This ensures that the upper part of the sample body can always move along the axis of symmetry. The upper part of the sample body is therefore always necessarily located at a distance from the storage device.

According to an embodiment of the invention, the storage device comprises a first storage device part and a second storage device part, wherein the first storage device part has a first opening, wherein the second storage device part has a second opening, wherein the opening of the storage device comprises the first opening and the second opening, wherein the first and the second openings are designed such that the central part of the sample body to be accommodated is free from material of the first storage device part and of second storage device part perpendicularly to the plane of extension of the sample body to be accommodated.

This could have the advantage that uniform heating of the central part of the sample body is ensured. The gasses used for temperature control can therefore flow around and uniformly heat the central part of the sample body from all sides.

According to an embodiment of the invention, the first storage device part forms the upper wall of the groove, wherein the second storage device part forms the lower wall of the groove.

According to an embodiment of the invention, the first storage device part and the second storage device part limit the movement of the lower part of the sample body to be accommodated perpendicularly to the plane of extension of the sample body to be accommodated, in which case the lower part of the sample body to be accommodated touches the first storage device part or the second storage device part, wherein the first storage device part and the second storage device part are designed to permit the lower part of the sample body to be accommodated to move along the axis of symmetry.

This could have the advantage that the lower part of the sample body is also protected against warping in the direction perpendicular to the plane of extension of the sample body. Nevertheless, thermal movement of the lower part of the sample body is possible.

According to an embodiment of the invention, the storage device furthermore comprises a positioning aid for the first storage device part and the second storage device part, wherein the positioning aid is designed to orient the first storage device part and the second storage device part relative to one another such that the first storage device part forms the upper wall of the groove and the second storage device part forms the lower wall of the groove.

This could have the advantage that the sample body can be easily inserted into the storage device. To this end, the sample body must be placed into the first storage device part and then the second positioning device is placed onto the first storage device part and the sample body by means of the positioning aid. The parts are automatically oriented relative to one another such that the sample body is not “clamped” and the parts of the sample body are able to move along the axis of symmetry of the sample body. At the same time, however, movement in the direction perpendicular to the plane of extension of the sample body is prevented.

In a further aspect, the invention relates to a temperature-control device, wherein the temperature-control device comprises a thermal cavity, e.g. a convection oven, wherein this oven is designed to accommodate a storage device, as described above.

Embodiments of the invention are explained in greater detail in the following with reference to the drawings. In the drawings:

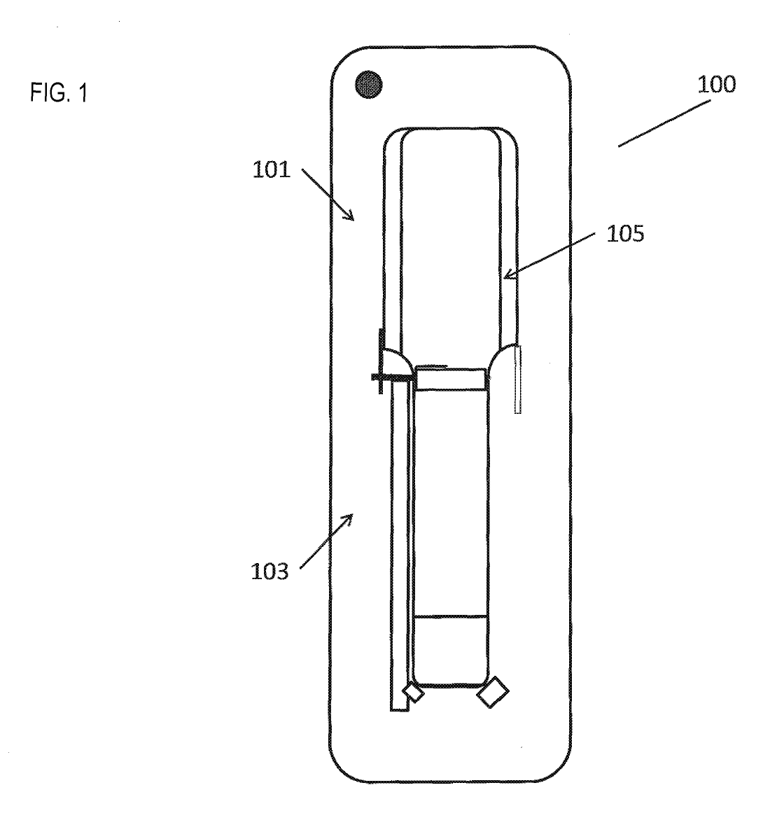

FIG. 1 shows a storage device for storing a sample body,

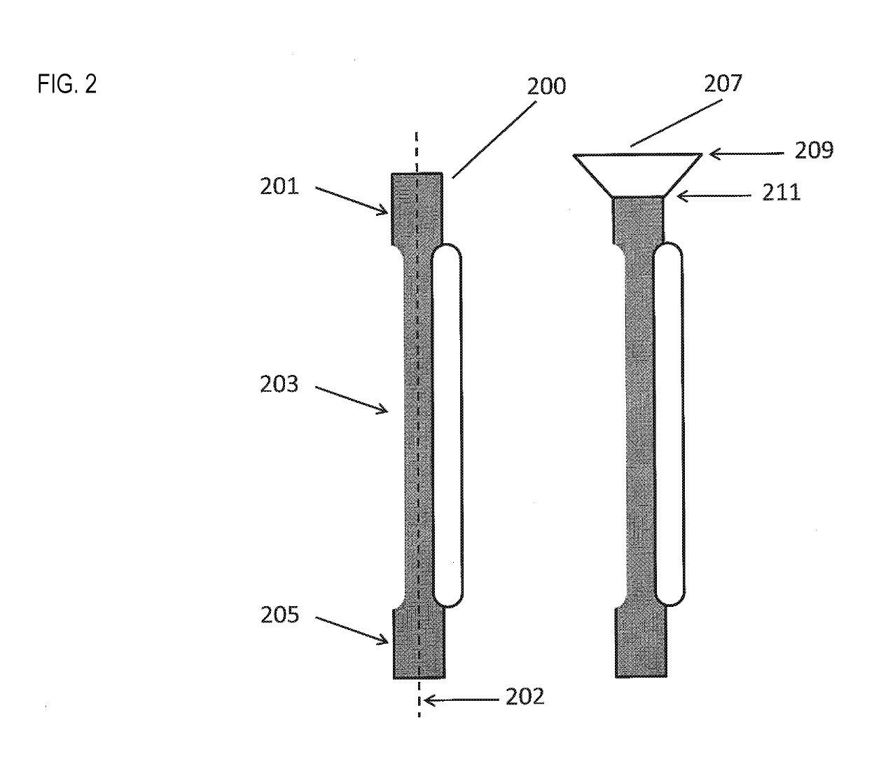

FIG. 2 shows a sample body and an arrangement of sample body and clamp,

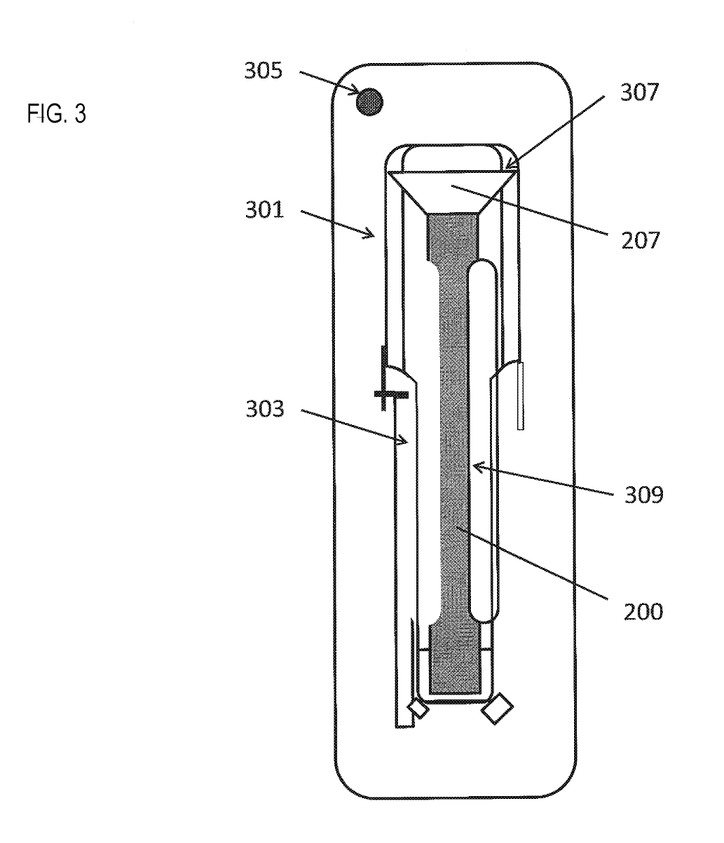

FIG. 3 shows an arrangement of a first storage device part, a sample body, and a clamp,

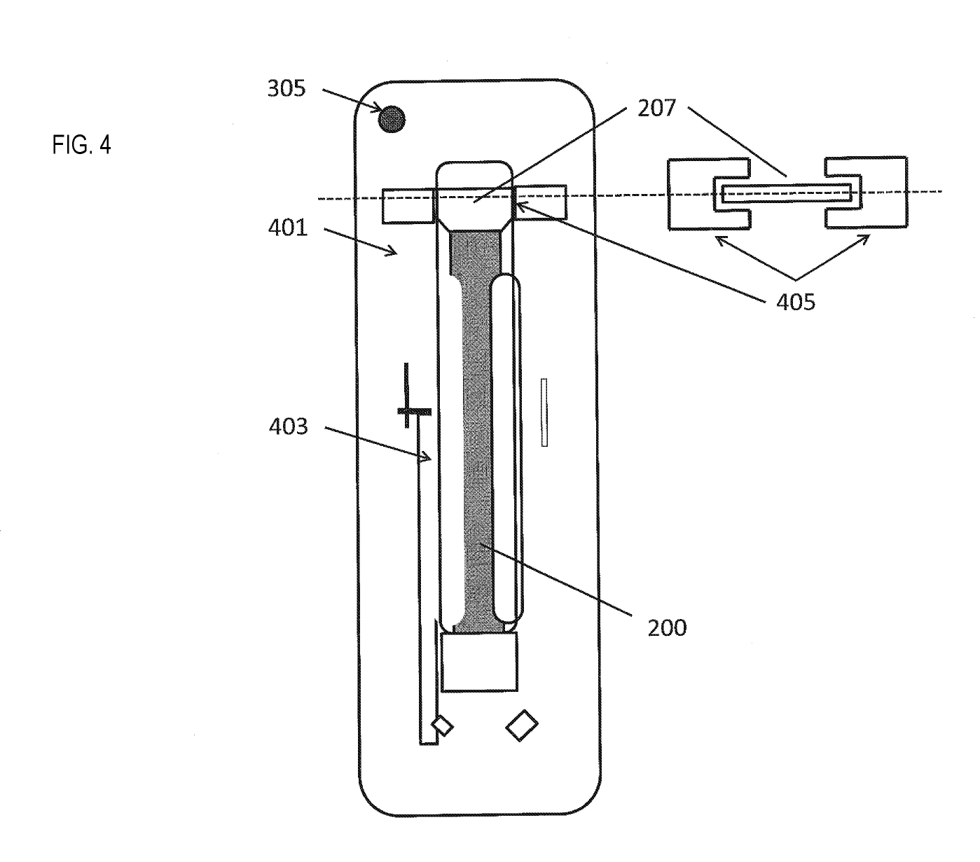

FIG. 4 shows an arrangement of a first storage device part, a second storage device part, a sample body, and a clamp.

Elements of the following embodiments that correspond to one another are labelled with the same reference characters.

FIG. 1 shows the storage device (100) for storing a sample body (200) shown in FIG. 2. The storage device comprises an opening that has an upper region (101) and a lower region (103). The walls of the upper region form a lateral guide (105) for the upper part of a sample body (201) to be accommodated, in order to permit an upper part of the sample body (200) to move along the axis of symmetry (202) of the sample body (200).

FIG. 2 shows the sample body (200) to be accommodated, which comprises an upper part (201) and, along the axis of symmetry (202) thereof, a central part (203) adjoining the upper part (201). Furthermore, the sample body (200) comprises, along the axis of symmetry (202), a lower part (205) adjoining the central part (203).

Temperature-controlled storage in an oven (not shown here) is necessary in order to investigate the thermal ageing of the sample body. To this end, the sample body (200) is usually stored in the unloaded state in the oven at different temperatures. The sample bodies must be stored in the oven for a long time period in such a way that said sample bodies do not warp during storage. This is the case since a warped sample body could falsify the measurement results in subsequent tensile tests, since force components form in the sample body that are not oriented exclusively parallel to the axis of symmetry (i.e. the tension axis) of the sample body.

The storage device described in FIG. 1 is used to permit storage of the sample body shown in FIG. 2, wherein the sample body is prevented from warping due to thermal heating in the oven and the sample body can thermally expand due to the heating.

It should be noted that the shape of the sample body (200) to be accommodated is not limited to the shape of the sample body shown in FIG. 2. This applies similarly to the storage device shown in FIG. 1. The shape of the storage device should be adapted to the shape of the sample body in such a way as to permit the upper part of the sample body (201) to thermally expand along the axis of symmetry (202). Furthermore, the shape of the storage device should be adapted to the shape of the sample body in such a way that the central part (203) of the sample body (200) to be accommodated is free from material of the storage device perpendicularly to the plane of extension of the sample body (200) to be accommodated. This enables uniform heating of the sample body during thermal storage.

Furthermore, FIG. 2 shows a clamp (207) for the non-positive accommodation of the upper part (201) of the sample body (200). Due to the non-positive accommodation, a normal force acts on the interconnected surfaces. The non-positive accommodation of the sample body (200) prevents the upper part (201) of the sample body from not bending in the thermal cavity during temperature-controlled storage.

Furthermore, the clamp (207) has a first width (209) within the plane of extension and perpendicular to the axis of symmetry (202) of the sample body (200) to be accommodated. The upper part (201) of the sample body (200) has a second width (211) within the plane of extension and perpendicular to the axis of symmetry (202) of the sample body (200) to be accommodated. Furthermore, the first width (209) is greater than the second width (211). Therefore, the upper part (201) of the sample body (200) has no direct contact to the material of the storage device and is therefore unable to irreversibly connect to the storage device (100) during temperature-controlled storage. This ensures that the upper part of the sample body (200) can always move along the axis of symmetry (202) of the sample body (200).

FIG. 3 shows a first storage device part (301), whereby the first storage device part (301) has a first opening (303). The walls of the first opening (303) are formed such that, within the plane of extension and perpendicularly to the axis of symmetry (202) of the sample body (200) to be accommodated, the width of the opening (309) is at least 1.5 times as wide as the central part of the sample body (200) to be accommodated.

The storage device (301) therefore does not have thermal contact to the sample body (200) in this region. Gasses used to heat the sample body (200) during temperature-controlled storage of the sample body (200) can therefore flow around in a uniform manner.

Furthermore, FIG. 3 shows the clamp (207), wherein the walls of the upper region (101) form the lateral guide (307, 105), above the clamp (207), for the upper part (201) of the sample body (200) to be accommodated.

FIG. 3 also shows a positioning aid (305) for the first storage device part (301) and the second storage device part (401).

The positioning aid (305) is designed in such a way that the first (301) and second (401) storage device parts are oriented relative to one another such that the sample body can move along the axis of symmetry (202) of the sample body (200) while being limited in the direction perpendicular to the plane of extension of the sample body. The sample body 200 is prevented from warping in this direction perpendicularly to the plane of extension of the sample body.

FIG. 4 shows the arrangement of the first storage device part (301) of FIG. 3, the second storage device part (401), the sample body (200) shown in FIG. 2, and the clamp (207). FIG. 4 furthermore shows the side view of the arrangement of the first storage device part (301), the second storage device part (401), the sample body (200), and the clamp (207).

FIG. 4 also shows the positioning aid (305) for the first storage device part (301) and the second storage device part (401). The positioning aid (305) is designed to orient the first storage device part (301) and the second storage device part (401) relative to one another such that the first storage device part (301) forms the upper wall of a groove (405), and the second storage device part (401) forms the lower wall of the groove (405).

The upper and lower walls of the groove (405) limit the movement of the upper part (201) of the sample body (200) to be accommodated, as viewed perpendicularly to the plane of extension of the sample body (200) to be accommodated, in which case the clamp (207) touches the upper wall or the lower wall of the groove (405). The groove (405) is used to permit the upper part (201) of the sample body (200) to be accommodated to move along the axis of symmetry (202). The clamp can therefore glide in the groove in a guided manner. Since the storage device and the clamp are preferably made of metal, the clamp and the storage device are prevented from adhering to one another and, therefore, the upper part of the sample body and of the storage device are prevented from adhering to one another.

### LIST OF REFERENCE CHARACTERS

100 storage device
101 upper region
103 lower region
105 lateral guide
200 sample body
201 upper part of the sample body
202 axis of symmetry
203 central part of the sample body
205 lower part of the sample body
207 clamp
209 first width
211 second width
301 first storage device part
303 first opening
305 positioning aid
307 lateral guide above the clamp
309 width of the opening
401 second storage device part
403 second opening
405 groove

1. A system comprising
a sample body
a storage device for storing the sample body,
wherein the sample body comprises an upper part and, along an axis of symmetry thereof, a central part adjoining the upper part, wherein the storage device has a space, wherein the space has an upper region and a lower region, wherein the space is adapted to accommodate the sample body, and wherein the walls of the space are designed such that, when the sample body is accommodated, the central part of the sample body to be accommodated is located at a distance in a direction perpendicular to the axis of symmetry from the walls of the space; and
a clamp,
wherein the clamp is adapted to non-positively accommodate the upper part of the sample body, wherein the clamp has a first width in the direction, wherein the upper part of the sample body has a second width in the direction, wherein the aforementioned first width is greater than the aforementioned second width, wherein the walls of the upper region form the lateral guide, via the clamp, for the upper part of the sample body to be accommodated, wherein the walls of the upper region form a lateral guide for the clamp, in order to permit the clamp with the accommodated upper part of the sample body to move along the axis of symmetry of the sample body, and wherein the lateral guide is given by the walls of the upper region bearing against the upper part of the sample body to be accommodated.

2. The system according to claim 1, wherein the sample body is located inside the storage device.

3. The system according to claim 1, wherein the walls of the space are formed such that in the direction the width of the space is at least 1.5 times as wide as the central part of the sample body to be accommodated.

4. The system according to claim 1, wherein, as viewed along the axis of symmetry of the sample body, the size of the upper region is selected in such a way as to permit thermal expansion of the upper part of the sample body along the axis of symmetry.

5. The system according to claim 1, wherein the sample body comprises, along the axis of symmetry, a lower part adjoining the central part, and wherein the walls of the lower region limit the movement of the lower part of the sample body, in which case the lower part of the sample body touches the lower region.

6. The storage device according to claim 1, further comprising:
a groove, wherein the groove comprises an upper wall, a lower wall, and the wall of the upper region of the space,
wherein the upper and lower walls of the groove are adapted to limit the movement of the clamp accommodating the upper part of the sample body, as viewed perpendicularly to the direction and perpendicularly to the axis of the sample body, in which case the clamp accommodating the upper part of the sample body touches the upper wall or the lower wall of the groove, and wherein the groove is designed to permit the upper part of the sample body to be accommodated to move along the axis of symmetry.

7. The system according to claim 6, wherein the groove forms the lateral guide, via the clamp, for the upper part of the sample body to be accommodated.

8. The system according to claim 1, wherein the storage device comprises a first storage device part and a second storage device part, wherein the first storage device part has a first space, wherein the second storage device part has a second space, wherein the space of the storage device comprises the first space and the second space, and wherein the first space and the second space are designed such that the central part of the sample body to be accommodated is free from material of the first storage device part and of the second storage device part, perpendicular to the direction and perpendicular to the axis of the sample body.

9. The system according to claim 8, wherein the first storage device part forms the upper wall of the groove, and wherein the second storage device part forms the lower wall of the groove.

10. The system according to claim 8, wherein the first storage device part and the second storage device part are adapted to limit the movement of the lower part of the sample body to be accommodated, perpendicularly to the direction and perpendicularly to the axis of the sample body, in which case the lower part of the sample body to be accommodated touches the first storage device part or the second storage device part, and wherein the first storage device part and the second storage device part are designed to enable the lower part of the sample body to be accommodated to move along the axis of symmetry.

11. The system according to claim 9, furthermore comprising:
a positioning aid for the first storage device part and the second storage device part,
wherein the positioning aid is adapted to orient the first storage device part and the second storage device part relative to one another such that the first storage device part forms the upper wall of the groove, and the second storage device part forms the lower wall of the groove.

12. A system comprising a temperature-control device and a storage device according to claim 1, wherein the temperature-control device comprises:
a thermal cavity,
wherein said thermal cavity is adapted to accommodate the storage device.

13. The system according to claim 12, wherein the storage device is located inside the thermal cavity of the temperature-control device.

14. The system according to claim 10, further comprising:
a positioning aid for the first storage device part and the second storage device part,
wherein the positioning aid is adapted to orient the first storage device part and the second storage device part relative to one another such that the first storage device part forms the upper wall of the groove, and the second storage device part forms the lower wall of the groove.

15. A system comprising
a sample body;
a storage device for storing the sample body, wherein the sample body comprises an upper part and, along an axis of symmetry thereof, a central part adjoining the upper part, wherein the storage device has a space, wherein the space has an upper region and a lower region, wherein the space is adapted to accommodate the sample body, and wherein the walls of the space are designed such that, when the sample body is accommodated, the central part of the sample body to be accommodated is located at a distance in a direction perpendicular to the axis of symmetry from the walls of the space;
a clamp, wherein the clamp is adapted to non-positively accommodate the upper part of the sample body, wherein the clamp has a first width in the direction, wherein the upper part of the sample body has a second width in the direction, wherein the aforementioned first width is greater than the aforementioned second width, wherein the walls of the upper region form the lateral guide, via the clamp, for the upper part of the sample body to be accommodated, wherein the walls of the upper region form a lateral guide for the clamp, in order to permit the clamp with the accommodated upper part of the sample body to move along the axis of symmetry of the sample body, and wherein the lateral guide is given by the walls of the upper region bearing against the upper part of the sample body to be accommodated; and
a temperature-controlled device comprising a thermal cavity, wherein said thermal cavity is adapted to accommodate the storage device.

16. The system according to claim 15, wherein the storage device comprises a first storage device part and a second storage device part, wherein the first storage device part has a first space, wherein the second storage device part has a second space, wherein the space of the storage device comprises the first space and the second space, and wherein the first space and the second space are designed such that the central part of the sample body to be accommodated is free from material of the first storage device part and of the second storage device part, perpendicular to the direction and perpendicular to the axis of the sample body.

17. The system according to claim 15, wherein the groove forms the lateral guide, via the clamp, for the upper part of the sample body to be accommodated.

18. The system according to claim 15, wherein the sample body is located inside the storage device.

19. The system according to claim 15, wherein, as viewed along the axis of symmetry of the sample body, the size of the upper region is selected in such a way as to permit thermal expansion of the upper part of the sample body along the axis of symmetry.

20. The system according to claim 15, wherein the storage device further comprises:
a groove, wherein the groove comprises an upper wall, a lower wall, and the wall of the upper region of the space,
wherein the upper and lower walls of the groove are adapted to limit the movement of the clamp accommodating the upper part of the sample body, as viewed perpendicularly to the direction and perpendicularly to the axis of the sample body, in which case the clamp accommodating the upper part of the sample body touches the upper wall or the lower wall of the groove, and wherein the groove is adapted to permit the upper part of the sample body to be accommodated to move along the axis of symmetry.
